(19) United States
(12) Patent Application Publication
(10) Pub. No.: US 2005/0063369 A1
(43) Pub. Date: Mar. 24, 2005

(54) Method of stacking multiple devices to create the equivalent of a single device with a larger port count

(76) Inventors: Abhijit K. Choudhury, Cupertino, CA (US); Mathew Kayalackakom, Cupertino, CA (US); Shekhar Ambe, San Jose, CA (US); Ken C. K. Chin, Saratoga, CA (US)

Correspondence Address: Pillsbury Winthrop LLP;Intellectual Property Group, Suite 200, 11682 El Camino Real, San Diego, CA, 92130-2092, US

(21) Appl. No.: 10/883,979

(22) Filed: Jul. 2, 2004

Related U.S. Application Data
(60) Provisional application No. 60/485,004, filed on Jul. 3, 2003.

(51) Int. Cl. H04L 12/66

(52) U.S. Cl. 370/360

(57) ABSTRACT

An apparatus provides an integrated single chip solution to solve Switching/Bridging, Security, Access Control, Bandwidth Management—Quality of Service issues, Roaming—Clean Hand off, Anticipatory Load Management, Location Tracking, Support for Revenue Generating Services—Fine grain QoS, Bandwidth Control, Billing and management. The architecture is such that it not only resolves the problems pertinent to WLAN it is also scalable and useful for building a number of useful networking products that fulfill enterprise security and wired and wireless networking needs. In accordance with a further aspect of the invention, the architecture supports stacking so as to enable the combining of two or more devices to create the equivalent of a single device with a larger port count, depending on system needs and preferences, while also providing support for services such as trunking, mirroring and QoS across all the ports.

### CROSS-REFERENCE TO RELATED APPLICATIONS

The present application claims priority to provisional application 60/485,004, filed on Jul. 3, 2003.

### FIELD OF THE INVENTION

Aspects of the present invention relate generally to network communications, and more particularly, to wired and wireless networks and architectures.

### BACKGROUND

The Wireless Local Area Network (WLAN) market has recently experienced rapid growth, primarily driven by consumer demand for home networking. The next phase of the growth will likely come from the commercial segment comprising enterprises, service provider networks in public places (Hotspots), multi-tenant, multi-dwelling units (MxUs) and small office home office (SOHOs). The worldwide market for the commercial segment is expected to grow from SM units in 2001 to over 33M units in 2006. However, this growth can be realized only if the issues of security, service quality and user experience are addressed effectively in newer products.

FIG. 1 illustrates possible wireless network topologies. As shown in FIG. 1, a wireless network 100 typically includes at least one access point 102, to which wireless-capable devices such as desktop computers, laptop computers, PDAs, cellphones, etc. can connect via wireless protocols such as 802.11a/b/g. Several or more access points 102 can be further connected to an access point controller 104. Switch 106 can be connected to multiple access points 102, access point controllers 104, or other wired and/or wireless network elements such as switches, bridges, computers, servers, etc. Switch 106 can further provide an uplink to another network. Many possible alternative topologies are possible, and this figure is intended to illuminate, rather than limit, the present inventions.

Problems with security, in particular, are relevant to all possible deployments of wireless networks. Most of the security problems have been brought on by flaws in the WEP algorithm which seriously undermine the security of the system making it unacceptable as an Enterprise solution. In particular, current wireless networks are vulnerable to:
Passive attacks to decrypt traffic based on statistical analysis.
Active attack to inject new traffic from unauthorized mobile stations, based on known plaintext.
Active attacks to decrypt traffic, based on tricking the access point.
Dictionary-building attacks that, after analysis of about a day's worth of traffic, allows real-time automated decryption of all traffic.

Analysis suggests that all of these attacks can be mounted using only inexpensive off-the-shelf equipment. Anyone using an 802.11 wireless network should not therefore rely on WEP for security, and employ other security measures to protect their wireless network. In addition WLAN also has security problems that are not WEP related, such as:
Easy Access—“War drivers” have used high-gain antennas and software to log the appearance of Beacon frames and associate them with a geographic location using GPS. Short of moving into heavily shielded office space that does not allow RF signals to escape, there is no solution for this problem.
“Rogue” Access Points—Easy access to wireless LANs is coupled with easy deployment. When combined, these two characteristics can cause headaches for network administrators. Any user can run to a nearby computer store, purchase an access point, and connect it to the corporate network without authorization an thus be able to roll out their own wireless LANs without authorization.
Unauthorized Use of Service—For corporate users extending wired networks, access to wireless networks must be as tightly controlled as for the existing wired network. Strong authentication is a must before access is granted to the network.
Service and Performance Constraints—Wireless LANs have limited transmission capacity. Networks based on 802.11b have a bit rate of 11 Mbps, and networks based on the newer 802.11a technology have bit rates up to 54 Mbps. This capacity is shared between all the users associated with an access point. Due to MAC-layer overhead, the actual effective throughput tops out at roughly half of the nominal bit rate. It is not hard to imagine how local area applications might overwhelm such limited capacity, or how an attacker might launch a denial of service attack on the limited resources.
MAC Spoofing and Session Hijacking—802.11 networks do not authenticate frames. Every frame has a source address, but there is no guarantee that the station sending the frame actually put the frame “in the air.” Just as on traditional Ethernet networks, there is no protection against forgery of frame source addresses. Attackers can use spoofed frames to redirect traffic and corrupt ARP tables. At a much simpler level, attackers can observe the MAC addresses of stations in use on the network and adopt those addresses for malicious transmissions.
Traffic Analysis and Eavesdropping—802.11 provides no protection against attackers that passively observe traffic. The main risk is that 802.11 does not secure data in transit to prevent eavesdropping. Frame headers are always “in the clear” and are visible to anybody with a wireless network analyzer.

There are no enterprise-class wireless network management systems that can address all of these problems. Attempts have been made to address certain of these problems, usually on a software level.

Meanwhile, however, many WLAN vendors are integrating combined 802.11a/g/b standards into their chipsets. Such chipsets are targeted for what are called Combo-Access Points which will allow users associated with the Access Points to share 100 Mbits of bandwidth in Normal Mode and up to ˜300 Mbits in Turbo Mode. The table below shows why a software security solution without hardware acceleration is not feasible when bandwidth/speeds exceed 100 Mbits.

| | | Required | | |
|---|---|---|---|---|
| | | Processor Speed | | |
| Interface | | [MHz] | | CPU |
| | BW | | IPSec + | Subsys |
| Type | [Mbs] | IPSec | Other | Cost |
| DSL | 1-5 | 133 | 200+ | |
| Ether | 10 | 300 | 500+ | |
| 802.11a | 30-50 | 1200 | 1500+ | $400 |
| | | | | [2002] |
| | | | | $125 |
| | | | | [2004] |
| Fast | 100 | 2500 | 3000+ | $600 |
| Ether | | | | [2002] |
| | | | | $250 |
| | | | | [2004] |

| | | |
|---|---|---|
| Multiple | 500 | Not Feasible in Software |
| FE | | Needs Dedicated Hardware |
| Gigabit | 1000 | |
| Ether | | |

Network access raises several concerns. Organizations today need reliable, flexible and secure methods for making public and confidential information available to users who can be classified into employees, customers, suppliers, and partners. As a result Authentication for Access to enterprise network is best if based on Role, or relationship (Local/Remote employee, Executive, department, business partner, customer), Site Accessed (A protected Web page, a partner site, Company's intranet site, Checking email, Accessing confidential documents, Checking a partner price list) or Access restrictions based to the time of day or connection duration.

One final issue with respect to wireless networking is the problem of Roaming and Session Persistence. Roaming allows the user to move from one network to another. (across same networks or across subnets) The user may do this intentionally to utilize a better or faster connection through a different Access Point or because user location has changed. Assuming that the user is originally authenticated while roaming user authentication across a WLAN should be transparent. The user should not require any manual action or any special application. There should be no reconfiguration needed when the user changes from one subnet to another. Any reconfiguration necessary should be done automatically. When roaming across subnets the WLAN user will encounter a problem with DHCP. As client changes network the new DHCP-server will provide a new IP-address. This will result in a break in an ongoing connection/session.

“Session persistence” means more than forwarding packets to a user's new location. “Persistence” can refer to just the problem of having packets forwarded as users roam among subnets, coverage areas and network types (wired LANs, wireless LANs and wireless WANs). More generally, it should refer to transport and application session persistence because when a transport protocol cannot communicate to its peer, the underlying protocols, like TCP, assume that the disruption of service is due to network congestion. When this occurs these protocols back off, reducing performance and eventually terminating the connection. WLAN networks have coverage holes causing dropouts even with access point overlap. This impacts a mobile device's range of mobility.

Although infrastructures for wired networks have been highly developed, the above and other problems of wireless networks are comparatively less addressed. Meanwhile, there is a need to address situations where enterprises and/or networks may have any combination of both wired and wireless components.

### SUMMARY

Embodiments of the present invention relate generally to a single-chip solution that addresses current weaknesses in wireless networks, but yet is scalable for a multitude of possible wired and/or wireless implementations. Current solutions to resolve/overcome the weaknesses of WLAN are only available in the form of Software or System. These resolve only specific WLAN problems and they don't address all of the existing limitations of wireless networks.

In accordance with an aspect of the invention, an apparatus provides an integrated single chip solution to solve Switching/Bridging, Security, Access Control, Bandwidth Management—Quality of Service issues, Roaming—Clean Hand off, Anticipatory Load Management, Location Tracking, Support for Revenue Generating Services—Fine grain QoS, Bandwidth Control, Billing and management. The architecture is such that it not only resolves the problems pertinent to WLAN it is also scalable and useful for building a number of useful networking products that fulfill enterprise security and wired and wireless networking needs. In accordance with a further aspect of the invention, the architecture supports stacking so as to flexibly enable the combining of many devices to create the equivalent of a single device with a larger port count, depending on system needs and preferences, while also providing support for services such as trunking, mirroring and QoS across all the ports.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates wireless network topologies;

FIG. 2 is a block diagram illustrating a wired and wireless network device architecture in accordance with the present invention; and

FIG. 3 illustrates the ability of a network device according to the invention to be stacked with another similar device to create the equivalent of a single device with a larger port count.

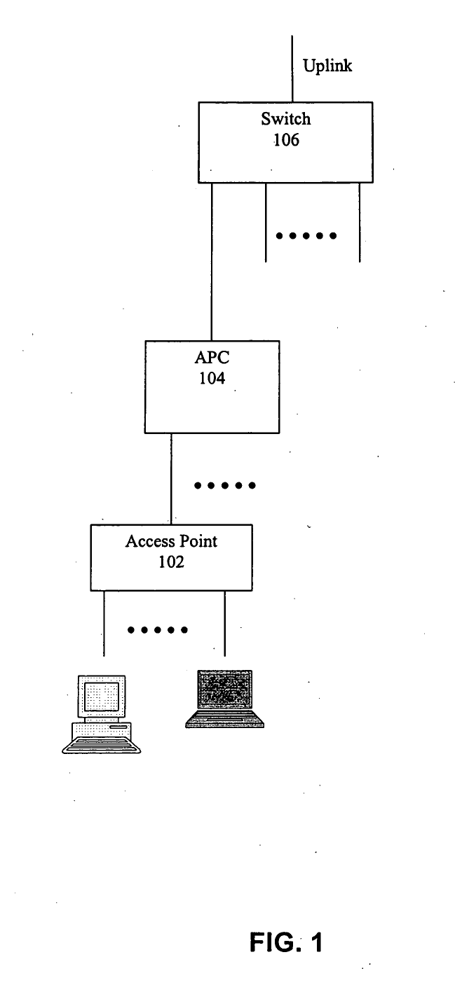

### DETAILED DESCRIPTION

One aspect of the present invention is the realization that it would be desirable to deliver a single chip solution to solve wired and wireless LAN Security, Access Control, Roaming, Session Persistence, Bandwidth Management and Quality of Service issues. Such a single chip solution may be scalable to enable implementation in the various components and alternative topologies of wired and/or wireless networks, such as, for example, in an access point, an access point controller, or in a switch. Some embodiments may be designed such that it could be “stacked” to create the equivalent of a single device with a larger port count.

Embodiments of the present invention will now be described in detail with reference to the drawings, which are provided as illustrative examples of the invention so as to enable those skilled in the art to practice the invention. Notably, the figures and examples below are not meant to limit the scope of the present invention. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Still further, the embodiments encompasses present and future known equivalents to the known components referred to herein by way of illustration, and implementations including such equivalents are to be considered alternative embodiments of the invention.

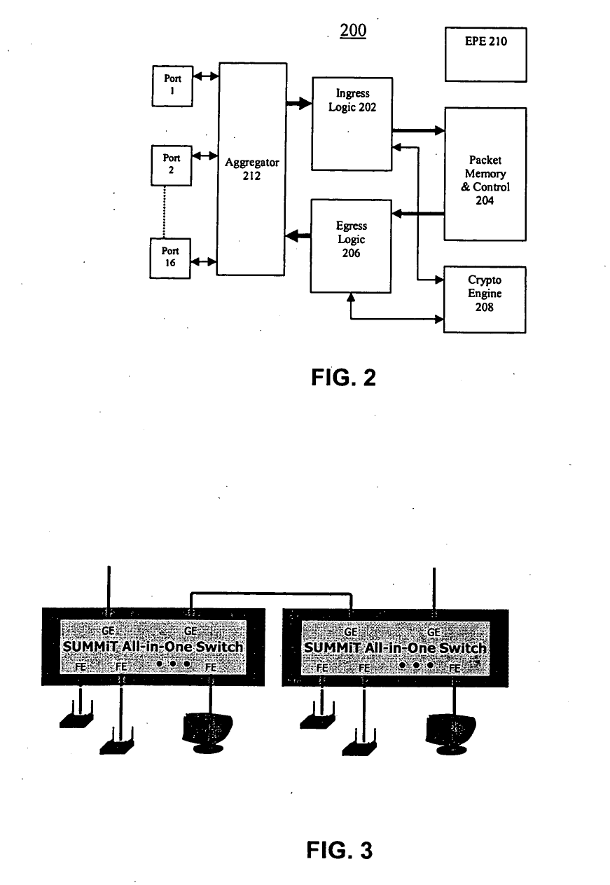

FIG. 2 is a block diagram illustrating an example implementation of a single-chip wired and wireless network solution in accordance with an aspect of the invention. As shown in FIG. 2, chip 200 includes ingress logic 202, packet memory and control 204, egress logic 206, crypto engine 208, an embedded processor engine 210 and an aggregator 212. An example implementation of device 200 is described in further detail in co-pending application Ser. No. ______ (Atty. Dkt. 79202-309844 (SNT-001)), the contents of which are incorporated herein by reference.

In accordance with a further aspect, a device 200 of the present invention includes the capability of “stacking.” One example of this is illustrated in FIG. 3. For example, two or more devices 200 can be stacked together using two GE ports to build a system with 24X (X=2 to n) FE ports plus 4 GE ports. What this implies is the following:
Two or four GE ports are dedicated as stacking ports and there is only stacking traffic through the ports.
Traffic through the stacking port is not encrypted.
The GE ports not used for stacking can be used as uplink ports.
The control CPU on the PCI bus is connected to all devices. There is one control CPU per stacked device or one Control CPU for the entire stacked solution.
VLAN membership involves all FE ports and 4 uplink ports on all devices.
Trunking membership involves all FE ports and 4 uplink ports on all devices.
The forwarding scope involves all FE ports and 4 uplink ports on all devices.
Multicast, broadcast, and unknown unicast involves all FE ports and 4 uplink ports on all devices.
The portmap information for the other device is aggregated in the stacking GE port so that the portmap remains the same as a single device.
Both the ingress security processing and egress editing processing are only done once when the packet comes in and once when it gets out from another.
The ingress packet lookup for traffic from the stacking GE port will still be performed (L2/L3 table lookup).
The following ingress forwarding scope determination is still done for traffic from the stacking GE port: packet parsing, VLAN/multicast/broadcast membership, trunking, ingress mirroring if mirror-to port in on the current device.
The egress packet security processing and packet editing for traffic to the stacking GE port will not be performed except for appending Stacking Header and replacing DSCP.
Traffic is normally “from wired” or “from wireless” although local switching is possible in that the traffic can go from one FE port to other FE ports, and one GE port to another GE port.
Inbound ACL is only done on the ingress device while outbound ACL is only done on the egress device.
Packet flow_id and priority are carried from the ingress device to the egress device.
The Stacking Header communicates the following information: packet flow_id and priority, receive device, receive port, mirror only packet indication, and mirrored requirement for current device.

According to another aspect of the invention, stacking is enabled while maintaining support for trunking, mirroring and QoS across all ports of the system.

Although the present invention has been particularly described with reference to the embodiments herein, it should be readily apparent to those of ordinary skill in the art that changes and modifications in the form and details may be made without departing from the spirit and scope of the invention. It is intended that the appended claims include such changes and modifications.

1. An apparatus for application in a wired and/or wireless network comprising:
a scalable ingress path;
a scalable egress path;
an aggregator configured to receive packets from ports, configured to provide a stream for the ingress path, configured to receive a stream from the egress path, and configured to output packet data to the ports;
wherein the apparatus is capable of being stacked with one or more other apparatuses to form a single management system with an increased number of ports, including support for trunking, mirroring or Quality of Service across all the ports.

2. The apparatus of claim 1 further comprising:
a decryptor block configured to perform decryption of the stream from the ingress path.

3. The apparatus of claim 2 further comprising:
an encryptor block configured to perform encryption of the stream from the egress path.

4. The apparatus of claim 3, wherein the scalable ingress path is further configured to determine whether the stream for the ingress path has to undergo decryption.

5. The apparatus of claim 3, wherein the scalable ingress path is further configured to determine whether the stream for the ingress path has to undergo authentication.

6. The apparatus of claim 4, further comprises:
a packet memory configured to store data from the stream for the ingress path and to the data stream for the egress path.

7. The apparatus of claim 6, further comprises:
a packet memory scheduler configured to schedule the data from the packet memory to the data stream for the egress path.

8. The apparatus of claim 7, wherein the scalable egress path is further configured to determine whether the stream for the egress path has to undergo encryption.

9. The apparatus of claim 8, wherein the scalable egress path is further configured to request that the encryptor block encrypt the stream for the egress path.

10. The apparatus of claim 9, wherein the decryptor block or the encryptor block supports 802.11i, IPSec, L2TP with IPSec, PPTP, or SSL Encryption algorithms.

11. The apparatus of claim 10, wherein the decryptor block or the encryptor block supports 802.11i, IPSec, L2TP with IPSec, PPTP, or SSL authentication algorithms.

12. The apparatus of claim 9, wherein the egress path or the ingress path further comprises:
access control logic configured to forward packets based an entry in an access control list.

13. The apparatus of claim 12, wherein the access control logic is further configured to:
drop packets based the entry on the access control list.

14. The apparatus of claim 13, wherein the access control logic is further configured to:
redirect packets based the entry on the access control list.

15. The apparatus of claim 14, wherein the packet is redirected to a port.

16. The apparatus of claim 13, wherein the access control logic is further configured to:
modify packets based the entry on the access control list.

17. The apparatus of claim 16, wherein the access control logic modifies 802.11p or DiffServ Code Point (DSCP) fields of the packet.

18. The apparatus of claim 13, wherein the access control logic is further configured to:
send the packet to a central processing unit (CPU) or Embedded Processing Engine (EPE) based the entry on the access control list.

19. The apparatus of claim 13, wherein the access control logic is further configured to:.
update a counter based the entry on the access control list.

20. The apparatus of claim 13, wherein the access control logic is further configured to:
assign a queue identifier to the packet based the entry on the access control list.

21. An method of processing data packets in a wired and/or wireless network comprising:
receiving a packet stream from one or more ports;
providing the packet stream to a scalable ingress path;
storing the packet stream;
outputting the packet stream to the one or more ports via a scalable egress path;
supporting a stacking with one or more other apparatuses to form a single management system with an increased number of ports, including support for trunking, mirroring or Quality of Service across all the ports.

22. The method of claim 21 further comprising:
determining whether the packet stream received from one or more ports has to undergo decryption.

23. The method of claim 22 further comprising:
decrypting the packet stream received from one or more ports when the packet stream requires decryption.

24. The method of claim 23 further comprising:
determining whether the packet stream received from one or more ports has to undergo authentication.

25. The method of claim 24 further comprising:
authenticating the packet stream received from one or more ports when the packet stream requires authentication.

26. The method of claim 25, further comprises:
scheduling the output of the packet stream to the one or more ports via a scalable egress path.

27. The method of claim 26, further comprises:
determining whether the packet stream in the scalable egress path has to undergo encryption.

28. The method of claim 27 further comprising:
encrypting the packet stream when the packet stream in the scalable egress path has to undergo encryption.

29. The method of claim 28, further comprising:
encrypting the stream for the egress path.

30. The method of claim 39, further comprising:
supporting 802.11i, IPSec, L2TP with IPSec, PPTP, or SSL Encryption algorithms.

31. The method of claim 30, further comprising:
supporting IPSec, L2TP with IPSec, PPTP, or SSL authentication algorithms.

32. The method of claim 29, further comprising:
forwarding packets based an entry in an access control list.

33. The method of claim 22, further comprising:
dropping packets based the entry on the access control list.

34. The method of claim 33, further comprising:
redirecting packets based the entry on the access control list.

35. The method of claim 34, wherein the packet is redirected to a port.

36. The method of claim 33, further comprising:
modifying packets based the entry on the access control list.

37. The method of claim 36, wherein 802.11p or DiffServ Code Point (DSCP) fields of the packet are modified.

38. The method of claim 33, further comprising:
sending the packet to a central processing unit (CPU) or Embedded Processing Engine (EPE) based the entry on the access control list.

39. The method of claim 33, further comprising:
updating a counter based the entry on the access control list.

40. The method of claim 33, further comprising:
assigning a queue identifier to the packet based the entry on the access control list.

41. A computer-readable medium, encoded with data and instructions, such that when executed by a computer, the instructions causes the computer to:
receive a packet stream from one or more ports;
provide the packet stream to a scalable ingress path;
store the packet stream;
output the packet stream to the one or more ports via a scalable egress path;
support a stacking with one or more other apparatuses to form a single management system with an increased number of ports, including support for trunking, mirroring or Quality of Service across all the ports.

42. The computer-readable medium of claim 41 further comprising instructions to:
determine whether the packet stream received from one or more ports has to undergo decryption.

43. The computer-readable medium of claim 42 further comprising instructions to:
decrypt the packet stream received from one or more ports when the packet stream requires decryption.

44. The computer-readable medium of claim 43 further comprising instructions to:
determine whether the packet stream received from one or more ports has to undergo authentication.

45. The computer-readable medium of claim 44 further comprising instructions to:
authenticate the packet stream received from one or more ports when the packet stream requires authentication.

46. The computer-readable medium of claim 45, further comprises instructions to:
schedue the output of the packet stream to the one or more ports via a scalable egress path.

47. The computer-readable medium of claim 46, further comprise instructions to s:
determine whether the packet stream in the scalable egress path has to undergo encryption.

48. The computer-readable medium of claim 47 further comprising instructions to:
encrypt the packet stream when the packet stream in the scalable egress path has to undergo encryption.

49. The computer-readable medium of claim 48, further comprising instructions to:
encrypt the stream for the egress path.

50. The computer-readable medium of claim 49, wherein the encryption is as per 802.11i, IPSec, L2TP with IPSec, PPTP, or SSL Encryption algorithms.

51. The computer-readable medium of claim 50, wherein the authentication encryption is as per 802.11i, IPSec, L2TP with IPSec, PPTP, or SSL Encryption algorithms.

52. The computer-readable medium of claim 49, further comprises instructions to:
forward packets based an entry in an access control list.

53. The computer-readable medium of claim 52, further comprises instructions to:
drop packets based the entry on the access control list.

54. The computer-readable medium of claim 53, further comprises instructions to:
redirect packets based the entry on the access control list.

55. The computer-readable medium of claim 54, wherein the packet is redirected to a port.

56. The computer-readable medium of claim 53, further comprises instructions to:
modify packets based the entry on the access control list.

57. The computer-readable medium of claim 56, wherein the access control logic modifies 802.11p or DiffServ Code Point (DSCP) fields of the packet.

58. The computer-readable medium of claim 53, further comprises instructions to:
send the packet to a central processing unit (CPU) or Embedded Processing Engine (EPE) based the entry on the access control list.

59. The computer-readable medium of claim 53, further comprises instructions to:
update a counter based the entry on the access control list.

60. The computer-readable medium of claim 53, further comprises instructions to:
assign a queue identifer to the packet based the entry on the access control list.

61. An apparatus of processing data packets in a wired and/or wireless network comprising:
means for receiving a packet stream from one or more ports;
means for providing the packet stream to a scalable ingress path;
means for storing the packet stream;
means for outputting the packet stream to the one or more ports via a scalable egress path;
means for supporting a stacking with one or more other apparatuses to form a single management system with an increased number of ports, including support for trunking, mirroring or Quality of Service across all the ports.

62. The apparatus of claim 61 further comprising:
means for determining whether the packet stream received from one or more ports has to undergo decryption.

63. The apparatus of claim 62 further comprising:
means for decrypting the packet stream received from one or more ports when the packet stream requires decryption.

64. The apparatus of claim 63 further comprising:
means for determining whether the packet stream received from one or more ports has to undergo authentication.

65. The apparatus of claim 64 further comprising:
means for authenticating the packet stream received from one or more ports when the packet stream requires authentication.

66. The apparatus of claim 65, further comprises:
means for scheduling the output of the packet stream to the one or more ports via a scalable egress path.

67. The apparatus of claim 66, further comprises:
means for determining whether the packet stream in the scalable egress path has to undergo encryption.

68. The apparatus of claim 67 further comprising:
means for encrypting the packet stream when the packet stream in the scalable egress path has to undergo encryption.

69. The apparatus of claim 68, wherein the scalable egress path is further configured to request that the encryptor block encrypt the stream for the egress path.

70. The apparatus of claim 69, further comprising:
means for supporting IPSec, L2TP with IPSec, PPTP, or SSL Encryption algorithms.

71. The apparatus of claim 70, further comprising:
means for supporting encryption is as per 802.11i, IPSec, L2TP with IPSec, PPTP, or SSL Encryption authentication algorithms.

72. The apparatus of claim 69, wherein the egress path further comprises:
means for forwarding packets based an entry in an access control list.

73. The apparatus of claim 72, further comprising:
means for dropping packets based the entry on the access control list.

74. The apparatus of claim 73, further comprising:
means for redirecting packets based the entry on the access control list.

75. The apparatus of claim 74, wherein the packet is redirected to a port.

76. The apparatus of claim 73, further comprising:
means for modifying packets based the entry on the access control list.

77. The apparatus of claim 76, wherein the access control logic modifies 802.11p or DiffServ Code Point (DSCP) fields of the packet.

78. The apparatus of claim 73, further comprising:
means for sending the packet to a central processing unit (CPU) or Embedded Processing Engine (EPE) based the entry on the access control list.

79. The apparatus of claim 73, further comprising:
means for updating a counter based the entry on the access control list.

80. The apparatus of claim 73, further comprising:
assign a queue identifer to the packet based the entry on the access control list.
